(19) United States
(12) Patent Application Publication
(10) Pub. No.: US 2023/0230001 A1
(43) Pub. Date: Jul. 20, 2023

(54) MANAGING AND AGGREGATING AVAILABLE RESOURCE INFORMATION FROM MULTIPLE CLOUD PROVIDERS

(71) Applicant: MICROSOFT TECHNOLOGY LICENSING, LLC, Redmond, WA (US)

(72) Inventor: Sagiv DRAZNIN, Walnut Creek, CA (US)

(21) Appl. No.: 17/579,569

(22) Filed: Jan. 19, 2022

(51) Int. Cl. G06Q 10/06; H04L 67/1097; H04L 67/62

(52) U.S. Cl. CPC G06Q 10/06314; H04L 67/325; H04L 67/1097

(57) ABSTRACT

The techniques described herein provide a system for executing a service that helps cloud resource providers manage unused cloud resources. Moreover, the service helps cloud resource consumers identify an optimal cloud platform to select for execution of an application. The service aggregates cloud resource information from multiple cloud providers and stores the cloud resource information in a data structure. The service then accesses the data structure to generate cloud resource offerings that can be published for review by different consumers. This process enables the consumers to see and compare cloud resource information, aggregated from multiple different cloud providers, in a single place (e.g., a complete and comprehensive user interface view into cloud resource information). More importantly, a consumer can make an efficient and informed decision as to which cloud provider and cloud platform to use for execution of an application.

### BACKGROUND

As cloud computing gains popularity, more and more data and/or services are stored and/or provided online via network connections. Providing an optimal and reliable experience is an important aspect for cloud resource providers that operate cloud platforms (e.g., AMAZON WEB SERVICES, MICROSOFT AZURE, GOOGLE CLOUD, etc.). In many scenarios, a cloud platform may provide service(s) to thousands or millions of tenants, customers, clients, users, etc. In order to provide these service(s), a cloud platform often includes geographically dispersed datacenters. Within an individual datacenter, the cloud platform configures and manages cloud infrastructure, which includes various resources that can be allocated for execution of an application (e.g., a service, a feature, a process, an algorithm, etc.) that belongs to a tenant, a customer, a client, a user, etc., collectively referred to herein as a cloud resource consumer, a cloud consumer, or just a consumer.

A cloud platform configures infrastructure that includes a fixed amount of resources. These resources include hardware resources such as physical machines (e.g., servers configured in various racks) for compute and storage purposes, physical networking equipment (e.g., network switches, network routers, etc.) for data communication purposes, and so forth. The cloud platform typically attempts to manage the fixed amount of resources to meet consumer demand, but this management task has proven to be difficult. Consequently, at a given time, a portion of the fixed amount of resources is often unused by consumers. If the unused amount of resources is large enough, a cloud platform operator may label the scenario wasteful and expensive as the cloud platform operator incurs costs to configure the unused resources so they are ready for consumption by consumers.

While some consumers may prefer to use a specific cloud platform to execute an application for compatibility with on-premises infrastructure or existing applications already executing in the cloud, there is a group of consumers that has the flexibility to use any one of multiple different cloud platforms operated by multiple different cloud resource providers. For instance, consumers may desire to execute applications in the shorter-term (e.g., the next twelve hours, the next day, the next two days, the next week, etc.). Typically, a consumer with this flexibility employs, or contracts with, an information technology (IT) professional to review the different cloud platforms with respect to the availability of resources, the capabilities of the available resources, and more importantly, the cost of the available resources. This manual review process implemented by the IT professional on the consumer side can be inefficient and costly, as the number of cloud platform operators continues to increase, creating more competition. For instance, the IT professional is required to engage with each cloud platform to determine which one has a sufficient amount of resources with the right capabilities, and at a minimum cost, to satisfy the technical requirements or technical preferences of an application.

It is with respect to these and other considerations that the disclosure made herein is presented.

### SUMMARY

The disclosed techniques implement a service that addresses the issues discussed above. That is, the service helps cloud resource providers, or cloud providers, that operate cloud platforms manage unused cloud resources. Moreover, the service helps cloud resource consumers identify an optimal cloud platform to select for execution of an application. The service aggregates cloud resource information from multiple cloud providers and stores the cloud resource information in a data structure. The service then accesses the data structure to generate cloud resource offerings that can be published for review by different consumers.

This process enables the consumers to see and compare cloud resource information, aggregated from multiple different cloud providers, in a single place (e.g., a complete and comprehensive user interface view into cloud resource information). More importantly, a consumer can make an efficient and informed decision as to which cloud provider and cloud platform to use for execution of an application. Consequently, a consumer no longer has to follow the inefficient process of finding and sorting through large amounts of cloud resource information from multiple different cloud providers, which is accessible via multiple different places, to find the best fit (e.g., the best cloud platform to execute the application).

The cloud resource information can include an amount (e.g., a volume) of available cloud resources (e.g., unused resources, spare resources, etc.), capabilities of the available cloud resources which may be referred to herein as “features” of the available cloud resources, and consumption costs associated with the available cloud resources. Further, the available cloud resources can comprise multiple different types of resources such as processing resources, storage resources, networking resources, security resources, and so forth. These types of resources are provided as examples, and it is understood in the context of this disclosure, that various cloud resource providers can offer other types of cloud resources as well. Furthermore, the cloud resources can comprise physical resources (e.g., hardware processing cores), virtual resources (e.g., virtual central processing units (vCPUs)), or a combination thereof.

Generally, an operator of a cloud platform prefers to manage and allocate its cloud resources in accordance with established agreements for consumers that desire consistent execution of their applications over a longer period of time (e.g., six months, a year, two years, etc.). However, in some instances, a consumer may desire cloud resources for a shorter time period (e.g., six hours, twelve hours, one day, two days, one week, one month, etc.). For example, a consumer may desire short-term cloud resources to execute an application that uses a specific algorithm to analyze end-of-the-year sales numbers, and this application may only need to be executed in the cloud once a year. In another example, a consumer may desire short-term cloud resources to execute a security application that reveals security flaws in the execution of other applications that execute over the longer period of time. In yet another example, a consumer may desire some additional cloud resource capacity to execute an application associated with processing electronic commerce transactions during a noted “busy” time period (e.g., the busiest week of the Holiday shopping season - Nov. 24 through Dec. 1).

As described above, there is room for cloud providers to improve the management of unused cloud resources that are available for use in the shorter-term (e.g., six hours, twelve hours, one day, two days, one week, one month, etc.). Accordingly, the service described herein is configured to implement a schedule for aggregating cloud resource information from multiple cloud resource providers and publishing various cloud resource offerings, derived or generated from the cloud resource information, to cloud resource consumers. The schedule includes a predefined time period during which a consumer can acquire and/or consume the cloud resources from a particular cloud provider. For example, the predefined time period can be a twelve hour window (e.g., 7am-7pm for a particular time zone), a twenty-four hour window (e.g., 7am-7am for a particular time zone), a full week (e.g., Monday through Sunday), etc. Generally, this predefined time period is smaller than the time periods associated with usual agreements between consumers and cloud resource providers, which outline longer time periods for consistent execution of their applications.

To obtain more consumers, the cloud providers are likely to offer the unused resources available in the short-term at a discounted price compared to resources that are being offered for long-term use. A down side of this short-term use for consumers is that the cloud providers make no guarantees with respect to resource availability, resource capability, and/or resource cost beyond the predefined time range. This helps the cloud providers justify charging the longer-term, and arguably more important, consumers a higher price. One may analogize this type of scenario to a grocer who discounts the price of a grocery item that has an expiration date in the near-term, rather than throw the grocery item out and be wasteful. For instance, a customer may buy a carton of milk about to expire at a discounted price, but the customer may have to drink the milk in two days before the expiration date. However, the same grocer may sell the same carton of milk with an extended expiration period (e.g., two weeks) at a regular price. Some customers still choose to pay the higher price so they have the full period — two weeks — to drink the milk before it spoils.

Accordingly, the techniques described herein provide a resource management benefit to cloud providers that have available resources for use in the short-term. Again, these resources are ones that are configured and ready, such that they are already incurring a fixed cost to the cloud providers. Therefore, the techniques described herein help avoid a scenario where a large portion of unused cloud resources and their associated costs are wasted. Furthermore, the aforementioned schedule enables a periodic approach in which cloud providers can iteratively analyze resource use to determine the amount of available resources to offer during each period (e.g., every twelve hours, every twenty-four hours, every two days, every week, etc.), and submit a solicitation request to the service for a given predefined time range based on the available resources. This enables a flexible and granular approach to resource management that is effective with respect to achieving an established goal with respect to resource use. The service can collect these solicitation requests from multiple cloud providers for each predefined time range, store the information in the solicitation requests in a data structure, and then use the data structure to generate cloud resource offerings so that consumers looking for short-term resource use can implement a one-stop approach to identifying and acquiring cloud resources.

The schedule may include a publication time when the cloud resource offerings for a given predefined time period are published. In one example, this publication time may coincide with a start time for the predefined time period (e.g., 7am each morning). In an alternative example, this publication time can occur before (e.g. one hour before) a start time for the predefined time period enabling a time slot for an information technology (IT) professional to review the published information. Further, the schedule may include a deadline for cloud providers to submit solicitation requests for a given predefined time period. This deadline can be a predetermined amount of time (e.g., two hours) before a start time for the predefined time period.

Once the cloud resource offerings are published and reviewed by a consumer, the service is configured to receive a request to consume a portion of available resources for an identified cloud provider during the predefined time period. The service can then submit the request, along with the identification of the consumer, to the identified cloud provider thereby enabling the cloud provider to establish an agreement with the consumer for allocation of the requested portion of cloud resources. For example, the agreement can be a service level agreement (SLA) that outlines performance expectations for an application and associated mappings to appropriate resource use.

Consequently, the service can execute like a broker in the sense that it connects a cloud resource provider with a cloud resource consumer looking for cloud resources in the short-term at an acceptable (e.g., discounted) price. In some examples, the broker may receive a commission, from the cloud provider, for the service provided. Alternatively, the service may act as a wholesaler that implements a bulk purchase of the available cloud resources from multiple cloud providers at wholesale prices and resells the purchased cloud resources to consumers at market prices that are typically higher than the wholesale prices.

In some examples, the service can implement automated actions to match a cloud provider with performance parameters (e.g., technical requirements or preferences) associated with execution of an application of a consumer. That is, the service can receive, from a consumer, a request that specifies the performance parameters associated with the execution of the application. The service may then access the data structure to analyze the cloud resource information received from the cloud providers for a given predefined time period. The service identifies a cloud provider that can satisfy the performance parameters in the request with respect to availability and capabilities of resources. The service can then provide the identified cloud provider to the consumer. With the consumer’s approval, the service can submit the request, along with the identification of the consumer, to the identified cloud provider thereby enabling the cloud provider to establish an agreement with the consumer for allocation of cloud resources.

As described above, the service disclosed herein provides a more efficient way for cloud providers to manage available resources, that will likely be wasted because they are going unused in the short-term. Moreover, the service provides a one-stop approach for consumers to acquire cloud resources, which are not only sufficient to meet the technical requirements or preferences associated with execution of an application, but are also likely to be offered at a lower price. Consequently, the disclosed techniques enable cloud providers to realize increased efficiency in their resource allocation systems. Furthermore, the disclosed techniques improve the consumer experience with respect to acquiring cloud resources for use.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates an environment in which a cloud broker service can aggregate information from multiple cloud resource providers and publish cloud resource offerings, based on the aggregated information, for multiple cloud resource consumers to review.

FIG. 2 is a diagram illustrating an example data structure that can be used to generate the cloud resource offerings.

FIG. 3A illustrates the environment in FIG. 1 where the cloud broker service connects a cloud resource consumer with a selected cloud resource provider so they can establish an agreement for resource use.

FIG. 3B illustrates the environment in FIG. 1 where the cloud broker service acts as a wholesale entity that purchases available cloud resources from the cloud resource provider and resells them to the cloud resource consumer.

FIG. 4A is a diagram illustrating an example schedule for aggregating the information from multiple cloud resource providers and publishing the cloud resource offerings based on the information for multiple cloud resource consumers to review.

FIG. 4B is a diagram illustrating another example schedule for aggregating the information from multiple cloud resource providers and publishing the cloud resource offerings based on the information for multiple cloud resource consumers to review.

FIG. 5 illustrates an environment in which a cloud broker service can aggregate information from multiple cloud resource providers and review cloud resource offerings so that a cloud resource consumer can be matched with a cloud resource provider.

FIG. 6 is a flow diagram of an example routine for aggregating resource information and publishing the resource information.

FIG. 7 is a flow diagram of an example routine for aggregating resource information and matching execution of a consumer application with a cloud resource provider.

FIG. 8 is an example computing system capable of implementing the techniques of the present disclosure.

### DETAILED DESCRIPTION

The techniques described herein provide a system for executing a service that helps cloud resource providers manage unused cloud resources. Moreover, the service helps cloud resource consumers identify an optimal cloud platform to select for execution of an application. The service aggregates cloud resource information from multiple cloud providers and stores the cloud resource information in a data structure. The service then accesses the data structure to generate cloud resource offerings that can be published for review by different consumers. This process enables the consumers to see and compare cloud resource information, aggregated from multiple different cloud providers, in a single place (e.g., a complete and comprehensive user interface view into cloud resource information). More importantly, a consumer can make an efficient and informed decision as to which cloud provider and cloud platform to use for execution of an application.

The cloud resource information can include an amount (e.g., a volume) of available cloud resources, capabilities of the available cloud resources which may be referred to herein as “features” associated with the available cloud resources, and consumption costs associated with the available cloud resources. Further, the cloud resources can comprise multiple different types of resources such as processing resources, storage resources, networking resources, security resources, and so forth. These types of resources are provided as examples, and it is understood in the context of this disclosure, that various cloud resource providers can offer other types of cloud resources as well. Furthermore, the cloud resources can comprise physical resources (e.g., processing cores), virtual resources (e.g., virtual central processing units (vCPUs)), or a combination thereof.

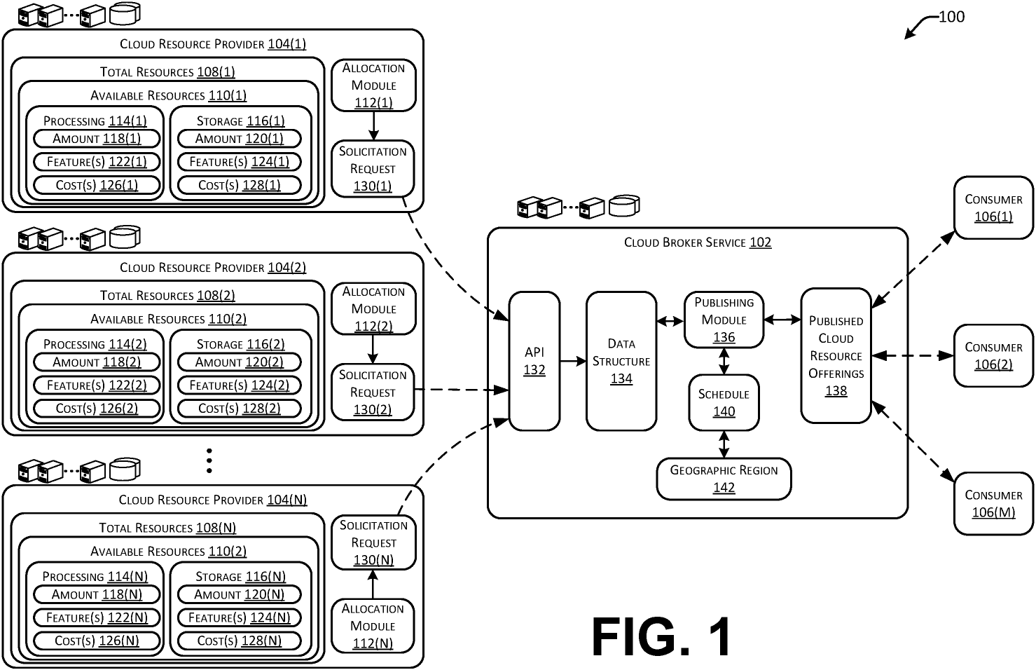

Various examples, scenarios, and aspects that enable the improved resource management and resource acquisition are described below with reference to FIGS. 1-8.

FIG. 1 illustrates an environment 100 in which a cloud broker service 102 can aggregate information from multiple cloud resource providers 104(1-N) (e.g., N represents a number such as two, three, four, five, ten, twenty, etc..) and publish cloud resource offerings, based on the aggregated information, for multiple cloud resource consumers 106(1-M) (e.g., M represents a number in the hundreds, thousands, or even millions).

The cloud resource providers 104(1-N) host cloud infrastructure that may be spread across various datacenters. This cloud infrastructure includes a total amount of resources 108(1-N) that the cloud resource providers 104(1-N) have respectively invested in so they are configured and ready for consumption by consumers. The total amount of resources 108(1-N) varies amongst the cloud resource providers 104(1-N). As shown in FIG. 1, a portion of the total amount of resources 108(1-N) configured by the cloud resource providers 104(1-N) remain available 110(1-N) at a given time. The available resources 110(1-N) varies amongst the cloud resource providers 104(1-N) as well.

The cloud resource providers 104(1-N) include allocation modules 112(1-N) that are configured to monitor and analyze the resource use for the total resources 108(1-N) and determine information associated with the available resources 110(1-N). In various examples, this information can be determined with respect to different types of resources. For instance, FIG. 1 illustrates available processing resources 114(1-N) and available storage resources 116(1-N) within the infrastructure of the cloud resource providers 104(1-N). These types of resources are provided as examples, and it is understood in the context of this disclosure, that various cloud resource providers can offer other types of cloud resources as well. Furthermore, the cloud resources can comprise physical resources (e.g., hardware processing cores), virtual resources (e.g., virtual central processing units (vCPUs)), or a combination thereof.

The information can include amounts 118(1-N) and 120(1-N) (e.g., a volume) of the available cloud resources based on type of resource, capabilities of the available cloud resources based on type of resource which are referred to as features 122(1-N) and 124(1-N), and consumption costs 126(1-N) and 128(1-N) associated with the available cloud resources based on type of resource (e.g., prices at which the consumer can acquire a unit of an available resource). The allocation modules 112(1-N) are configured to generate solicitation requests 130(1-N) that include the information associated with the available resources 110(1-N), and submit the solicitation requests 130(1-N) to the cloud broker service 102 via an application programming interface (API) 132, for example.

Generally, the cloud resource providers 104(1-N) prefer to manage and allocate their total amount of cloud resources 108(1-N) in accordance with established agreements for consumers that desire consistent execution of their applications over a longer period of time (e.g., six months, a year, two years, etc.). However, in some instances, consumers 106(1-M) may desire cloud resources for a shorter time period (e.g., six hours, twelve hours, one day, two days, one week, one month, etc.). For example, a consumer 106(1) may desire short-term cloud resources to execute an application that uses a specific algorithm to analyze end-of-the-year sales numbers, and this application may only need to be executed in the cloud once a year. In another example, a consumer 106(1) may desire short-term cloud resources to execute a security application that reveals security flaws in the execution of other applications that execute over the longer period of time. In yet another example, a consumer 106(1) may desire some additional cloud resource capacity to execute an application associated with processing electronic commerce transactions during a noted “busy” time period (e.g., the busiest week of the Holiday shopping season - Nov. 24 through Dec. 1).

To obtain more consumers 106(1-M), the cloud resource providers 104(1-N) are likely to offer the available resources 110(1-N) at a discounted price compared to resources that are being offered for long-term use. A down side of this short-term use for consumers 106(1-M) is that the cloud resource providers 104(1-N) make no guarantees with respect to resource availability, resource capability, and/or resource cost beyond a predefined time range. This helps the cloud resource providers 104(1-N) justify charging the longer-term, and arguably more important, consumers a higher price. One may analogize this type of scenario to a grocer who discounts the price of a grocery item that has an expiration date in the near-term, rather than throw the grocery item out and be wasteful. For instance, a customer may buy a carton of milk about to expire at a discounted price, but the customer may have to drink the milk in two days before the expiration date. However, the same grocer may sell the same carton of milk with an extended expiration period (e.g., two weeks) at a regular price. Some customers still choose to pay the higher price so they have the full period — two weeks — to drink the milk before it spoils.

As described above, there is room for the cloud resource providers 104(1-N) to improve the management of the available resources 110(1-N) that, if not used in the short-term (e.g., the next six hours, the next twelve hours, the next day, the next two days, the next week, the next month, etc.), will go wasted. Accordingly, the cloud service broker 102 receives the solicitation requests 130(1-N) received from the cloud resource providers 104(1-N), aggregates them, and stores them in a data structure 134. The cloud broker service 102 further includes a publishing module 136 configured to access the data structure 134 and generate cloud resource offerings 138 that can be published for review by the consumers 106(1-M).

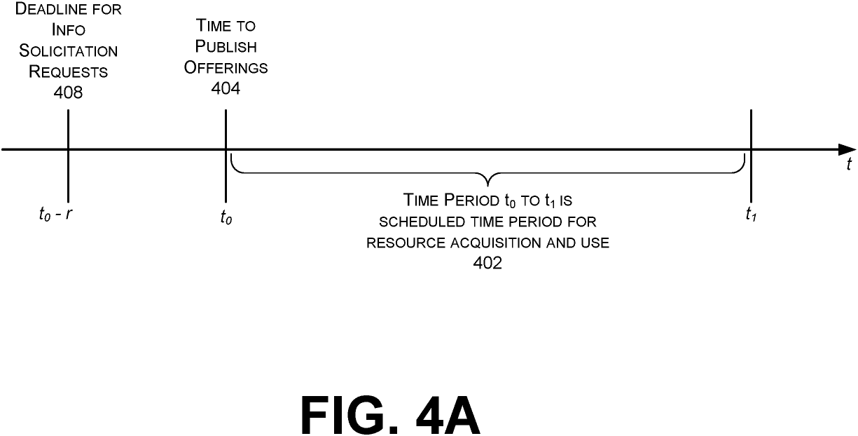

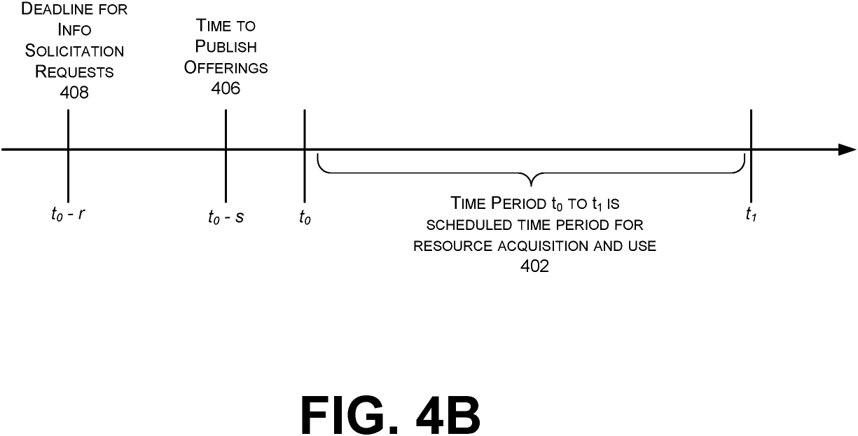

As a third-party entity configured between multiple cloud resource providers 104(1-N) and multiple consumers 106(1-M), the cloud broker service 102 implements a schedule 140 for aggregating the cloud resource information included in the solicitation requests 130(1-N) received from the cloud resource providers 104(1-N), and publishing the cloud resource information for the consumers 106(1-M). The aggregation and publication may be associated with a predefined time period when the resources can be used by consumers 106(1-M). In various examples, the schedule 140 is implement with respect to a specific geographic region 142 (e.g., a time zone, a country, etc.) Examples of the schedule 140 are provided herein with respect to FIGS. 4A-4B. Accordingly, the cloud broker service 102 can replicate the techniques described herein across different geographic regions.

Generally, this schedule 140 enables a periodic approach in which the cloud resource providers 104(1-N) can iteratively analyze resource use to determine the amounts of available resources 118(1-N) and 120(1-N) to offer during each period (e.g., every twelve hours, every twenty-four hours, every two days, every week, every month, etc.). This enables a flexible and granular approach to resource management that is effective with respect to achieving an established goal with respect to resource use (e.g., maximize resource use, maximize revenue, etc.). For example, the allocation modules 112(1-N) can implement a machine learning algorithm to determine costs of available resources for consumers for future periods based on consumer demand and what consumers paid in previous periods. More specifically, if the predefined time period is a day, this sort of an analysis enables the cloud resource providers 104(1-N) to adjust consumer prices lower or higher from day-to-day, to allow for higher consumer acquisition, additional resource use, and increased revenue in the short-term.

Additionally, the schedule 140 enables an even playing field for all the cloud resource providers 104(1-N) with respect to short-term customer acquisition in a “market-based” scenario. For example, the cloud broker service 102 can use strict security measures (e.g., encryption for communication and storage) to keep the cloud resource information private prior to the information being published. Moreover, the cloud broker service 102 may implement a policy that no further solicitation requests 130(1-N) for a given predefined time period can be received after a submission deadline which occurs before publication. Consequently, one cloud resource provider 104(1) is unaware of how another cloud resource provider 104(2) has priced available resources prior to the publication of the information, which occurs after the solicitation requests 130(1-N) are sent/received.

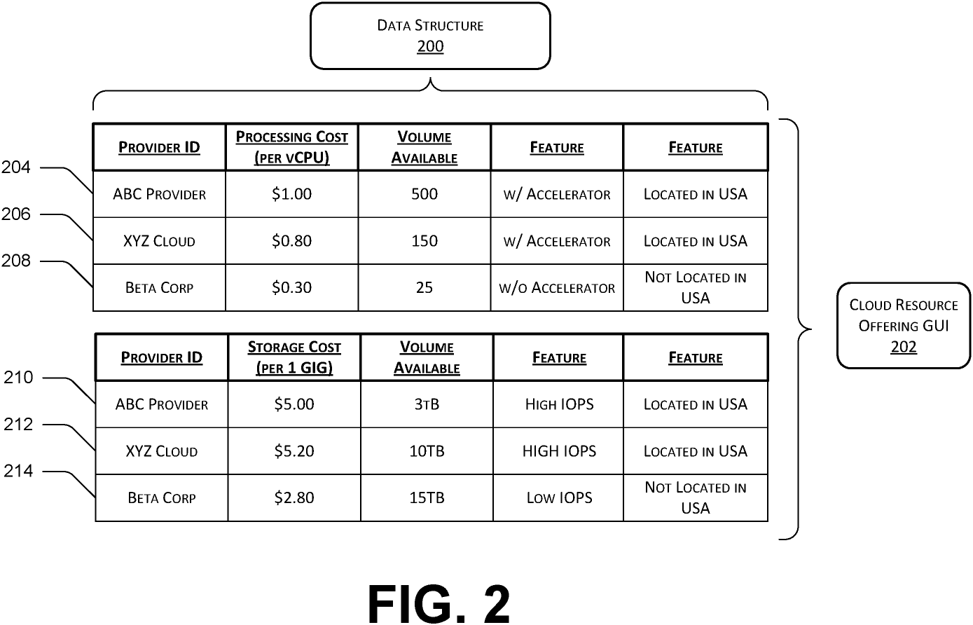

FIG. 2 is a diagram illustrating an example data structure 200 that can be used to generate the cloud resource offerings 138. As shown, the data structure 200 can include fields for cloud provider identifications (e.g., “ABC Provider”, “XYX Cloud”, “Beta Corp”), costs for a unit of a resource (e.g., a virtual central processing unit (vCPU) for processing resources, one gigabyte for storage resources) being charged by each of the identified cloud providers, the volume of a resource available at each of the identified cloud providers, and features associated with the available resources (e.g., whether there is an accelerator, whether the underlying hardware is located in the United States of America, etc.). The data structure 200 can be formatted such that each row is an offering, and multiple different offerings from multiple different providers can be viewed and compared by consumers in a single cloud resource offering graphical user interface (GUI) 202. In some examples, the offerings are sorted and stored according to type of resource.

Note that the information shown in the data structure 200 is example information only, and may be simplified for ease of discussion. Practically, the cost and the volume for a resource may be larger (or smaller), the units may be different, and/or the number of features that affect the technical performance and/or price may be larger (or smaller). Moreover, the offerings may require that a consumer purchase all of the available volume, or enable the consumer to purchase a portion of the available volume.

As shown, a first offering 204 shows that ABC Provider is offering a vCPU, the processing resource unit, for $1.00 for the predefined time range, and that ABC Provider has five hundred of these vCPUs available. Further, the first offering 204 indicates that these vCPUs have an accelerator feature and the processing will be implemented in the United States (e.g., location of resource usage may be important for compliance and policy issues, as well as latency). A second offering 206 shows that XYZ Cloud is offering a vCPU for $0.80 for the predefined time range, and that XYZ Cloud has one hundred and fifty of these vCPUs available. Further, the second offering 206 indicates that these vCPUs have an accelerator feature and the processing will be implemented in the United States. A third offering 208 shows that Beta Corp is offering a vCPU for $0.30 for the predefined time range, and that Beta Corp has only twenty-five of these vCPUs available. Further, the third offering 208 indicates that these vCPUs do not have an accelerator feature and the processing will not be implemented in the United States. As shown, a cloud resource provider may consider the features and/or volume of an available resource to set the cost, or price, for the consumer. Moreover, the cloud resource provider can use historical data and/or machine learning to adjust the price from one predefined time period to the next, as discussed above.

A consumer can see and compare these different offerings 204, 206, 208 to find the best price for what the consumer needs with respect to processing. For instance, if the consumer needs or prefers vCPUs with accelerators for execution of the application and if the consumer requires that the processing occur in the United States, the consumer can save money by acquiring the resources from XYZ Cloud. However, if the user prefers or needs more than one hundred and fifty vCPUs with the aforementioned features, the user may have to pay more and acquire the resources from ABC Provider. If the consumer does not need or prefer vCPUs with accelerators for execution of the application and does not require that the processing occur in the United States, the consumer can save money by acquiring processing resources from Beta Corp, assuming the consumer does not need more than twenty-five vCPUs.

With respect to storage, a fourth offering 210 shows that ABC Provider is offering a gigabyte of storage, the storage resource unit, for $5.00 for the predefined time range, and that ABC Provider has three terabytes of storage available. Further, the fourth offering 210 indicates that the storage has a high input/output operations per second (IOPS) feature and the data storage is the United States. A fifth offering 212 shows that XYZ Cloud is offering a gigabyte of storage for $5.20 for the predefined time range, and that XYZ Cloud has ten terabytes of storage available. Further, the fifth offering 212 indicates that the storage has a high IOPS feature and the data storage is the United States. A sixth offering 214 shows that Beta Corp is offering a gigabyte of storage for $2.80 for the predefined time range, and that Beta Corp has fifteen terabytes of storage available. Further, the sixth offering 214 indicates that the storage has a low IOPS feature and the data storage is not in the United States.

Consequently, the consumer can review and consider different cloud resource information with respect to storage, in order to identify a best fit for execution of the application. Note that in most cases, two separate offers may be associated with another. For instance, since storage is likely needed to store processed information, when a consumer is making a decision as to which cloud provider to use, the consumer may have to consider offering 210 with offering 204 from ABC provider, offering 212 with offering 206 from XYZ Cloud, and offering 214 with offering 208 from Beta Corp.

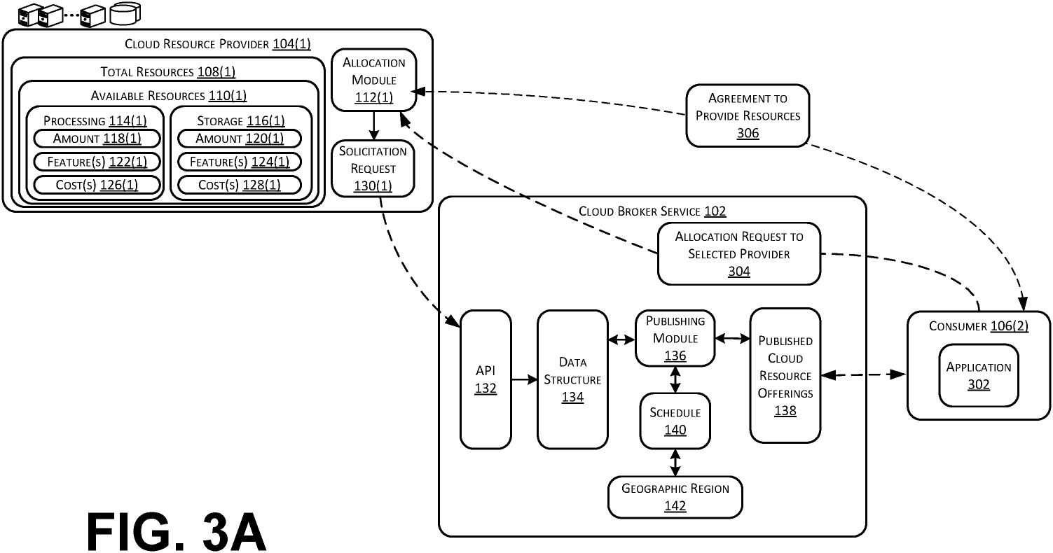

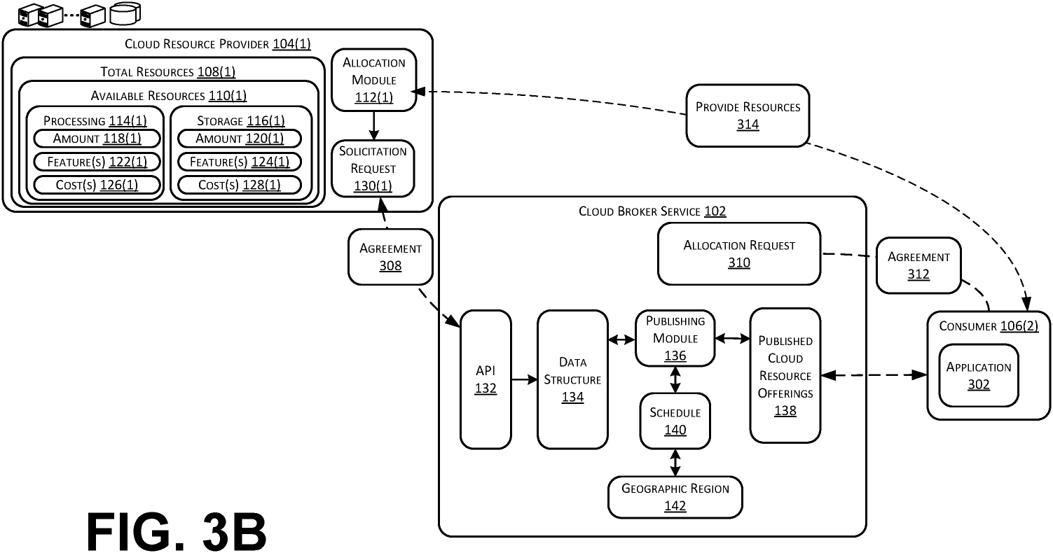

FIG. 3A illustrates the environment 100 in FIG. 1, where the cloud broker service 102 connects a cloud resource consumer 106(2) with a selected cloud resource provider 104(1) so they can establish an agreement for resource use. This connection reveals the identifications of the cloud resource provider 104(1) and the cloud resource consumer 106(2) after the cloud resource consumer 106(2) has considered the published offerings 138 from the data structure 134, and made a decision on which cloud resource provider to select based on the performance parameters that are preferred or needed for execution of an application 302.

As shown, the consumer 106(2) sends, and the cloud broker service 102 receives, an allocation request 304 that identifies the selected cloud resource provider 104(1), as well as a portion of the available resources (e.g., a number of vCPUs, a number of gigabytes of storage, etc.) the consumer desires to acquire (e.g., purchase) during the predefined time period. The cloud broker service 102 can then submit the allocation request 304, along with the identification of the consumer 106(2), to the identified cloud resource provider 104(1) thereby enabling the cloud resource provider 104(1) to establish an agreement 306 with the consumer 106(2) for the allocation and provision of the requested cloud resources. For example, the agreement can be a service level agreement (SLA) that outlines performance expectations for an application and associated mappings to appropriate resource use.

Consequently, the cloud broker service 102 connects a cloud resource provider with a cloud resource consumer looking for cloud resources in the short-term at an acceptable (e.g., discounted) price. In some examples, the cloud broker service 102 may receive a commission, from the cloud resource provider 104(1), for the service provided. In further examples, the cloud broker service 102 may be authorized to implement the agreement 306 with the consumer 106(2) on behalf of the cloud resource provider 104(1).

Alternatively, the cloud broker service 102 may act as a wholesaler that implements a bulk purchase of the available cloud resources from multiple cloud providers at wholesale prices and resells the purchased cloud resources to consumers at market prices that are typically higher than the wholesale prices. For instance, FIG. 3B illustrates an agreement 308 between the cloud broker service 102 and the cloud resource provider 104(1) to purchase available resources at first prices. The cloud broker service 102 may then publish their own prices in the offering to consumers. When an allocation request 310 is received, in this example, the cloud broker service 102 establishes another agreement 312 with the consumer 106(2) which provisions some of the previously purchases resources 314 from cloud resource provider 104(1).

FIG. 4A is a diagram illustrating an example schedule 140 for aggregating the information from multiple cloud resource providers 104(1-N) and publishing the cloud resource offerings based on the information for multiple cloud resource consumers 106(1-M) to review. As described above, the cloud broker service 102 is configured to collect and store solicitation requests 130(1-N) from multiple cloud providers for a predefined time period, t₀ to t₁, during which the resources can be acquired (e.g., purchased) and used 402. For example, the predefined time period, t₀ to t₁, can be a twelve hour window (e.g., 7am-7pm for a particular time zone), a twenty-four hour window (e.g., 7am-7am for a particular time zone), a full week (e.g., Monday through Sunday), etc. As described above, this predefined time period, t₀ to t₁, is smaller than the time periods associated with usual agreements between consumers and cloud resource providers, which outline longer time periods for consistent execution of their applications.

The schedule may also include a publication time when the cloud resource offerings for a given predefined time period 402 are published. In the example of FIG. 4A, this publication time 404 coincides with a start time, t₀, for the predefined time period (e.g., 7am each morning). In an alternative schedule example shown in FIG. 4B, this publication time 406 can occur a time, s, (e.g. one hour) before the start time, t₀, for the predefined time period. This allows a time slot for an information technology (IT) professional on the consumer to side to review the published information and make a decision before the time period for acquisition and resource use starts.

Further, the example schedules shown in FIGS. 4A and 4B may include a deadline 408 imposed on the cloud resource providers 104(1-N) to submit their solicitation requests 130(1-N) for a given predefined time period. This deadline can be a predetermined amount of time, r, (e.g., two hours) before the start time, t₀, for the predefined time period. As described above, this makes the whole approach fair for the market scenario, and also allows time for the cloud broker service 102 to generate the offerings. Further, the cloud broker service 102 is configured to refrain from, or stop, the publishing of the cloud resource offerings upon expiration of the predefined time period. This enables the market scenario to completely reset and reiterate the process for the next predefined time period.

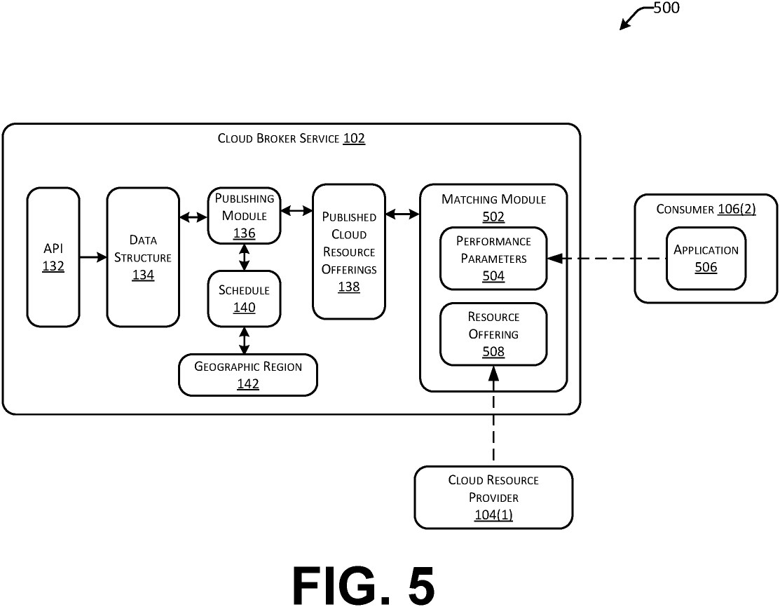

FIG. 5 illustrates an environment 500 in which a cloud broker service can aggregate information from multiple cloud resource providers and review cloud resource offerings so that a cloud resource consumer can be matched with a cloud resource provider. In this example, the cloud broker service 102 implements a matching module 502 that receives, from a consumer 106(2), a request that specifies performance parameters 504 associated with the execution of an application 506. The matching module 502 may then review the published cloud resource offerings 138 for a given predefined time period, and automatically match the performance parameters 504 with a resource offering 508 that can satisfy the performance parameters 504. The cloud broker service 102 can then provide the identification of a cloud resource provider associated with the resource offering 508 to the consumer 106(2), as well as the information in the offering. With the consumer’s approval, the cloud broker service 102 can submit the request, along with the identification of the consumer, to the identified cloud resource provider thereby enabling the cloud resource provider to establish an agreement with the consumer 106(2) for allocation of cloud resources.

In various examples, the matching module 502 can calculate a total cost to the consumer, based on the performance parameters 504 requested, in consideration of the offerings that satisfy the performance parameters. This ranking can then be provided to the consumer for consideration, and the consumer can select the cloud resource provider from which resources will be acquired. This automated calculation may be beneficial to the consumer 106(2) when a large number of cloud resource providers can offer resources that satisfy the performance parameters 504. In some instances, a cloud resource provider may implement complex costs structures (e.g., a first price for a first number of units of a resource, a second price for a second number of units of the resource, etc.), so this automated calculation may alleviate the need for the consumer 106(2) to spend the time and resources to make their own calculations for comparison purposes.

The performance parameters 504 can define technical requirements or preferences that are requested by the consumer 106(2) in association with execution of the application 506. A first example of a performance parameter 504 can include a number of virtual central processing units (vCPUs) to be allocated for execution of an application. A vCPU represents a portion or share of the underlying, physical CPU that is assigned to a particular virtual machine (VM).

A second example of a performance parameter 504 can include an amount of storage for execution of the application (e.g., two gigabytes). More demanding applications likely require more storage compared to less demanding applications.

A third example of a performance parameter 504 can include whether the application has a central processing unit (CPU) pinning requirement. CPU pinning binds a process or a thread to a designated CPU or to a range of dedicated CPUs, so that the process or thread executes only on the designated CPU or the range of dedicated CPUs rather than any CPU.

A fourth example of a performance parameter 504 can include an amount of input/output operations (e.g., measured per second) for execution of the application. Again, more demanding applications likely require more input/output operations per second compared to less demanding applications.

A fifth example of a performance parameter 504 can include an anti-affinity or an affinity requirement for execution of the application. An anti-affinity requirement increases resiliency by implementing a rule ensuring or requesting that two application elements (e.g., VMs) are not executed on the same underlying physical server. In contrast, an affinity requirement implements a rule ensuring or requesting that two application elements (e.g., VMs) are executed on the same underlying physical server.

A sixth example of a performance parameter 504 can include a defined amount of tolerance for oversubscription of cloud resources. As this tolerance increases, the chance of a fault or interruption in the execution of the application increases.

Other performance parameters that can be satisfied via the allocation and offerings of resources are also contemplated in the context of this disclosure. In some examples, a consumer can make a high-level declaration in the performance parameters 504 such as expected use of an application, a type or priority of application (e.g., health, financial, social media, content delivery, streaming, etc.), conditions with respect to timeliness of execution of the application, whether the application requires state to be maintained (i.e., a state vs. stateless application), etc. The matching module 502 may be configured to translate these high-level declarations into resource usage in order to implement the matching and/or ranking discussed above.

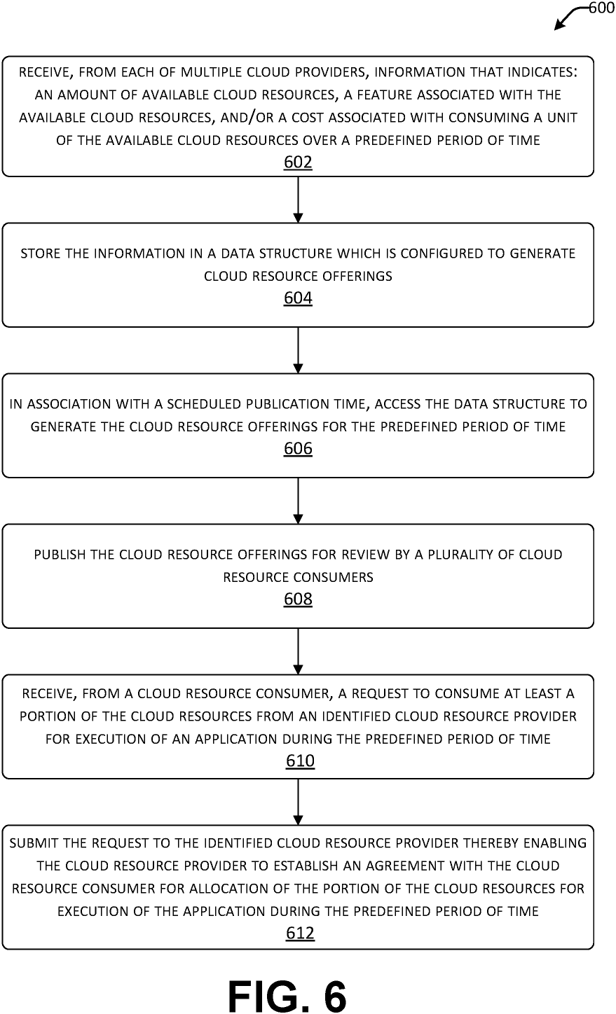

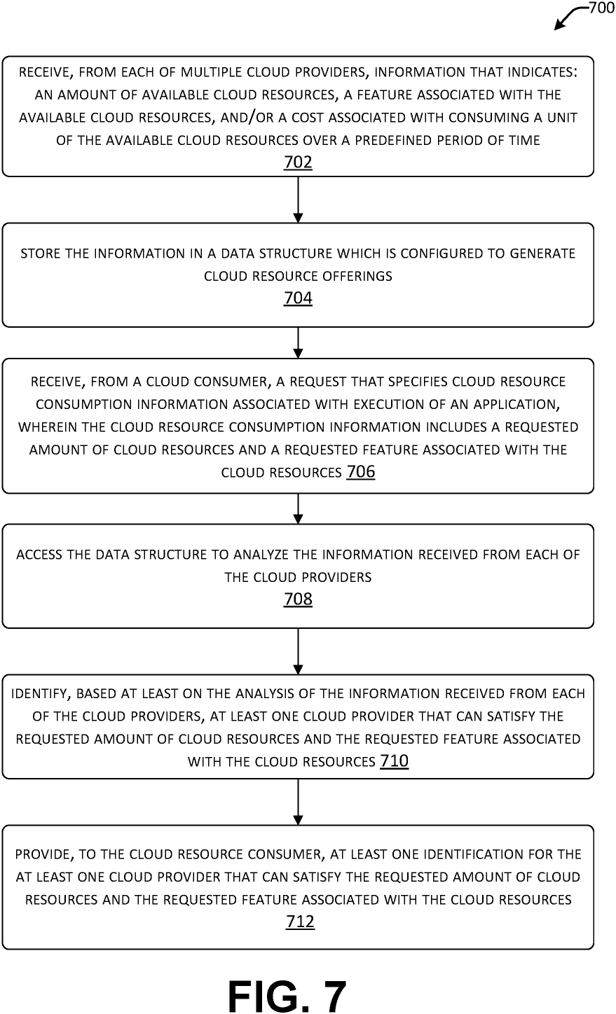

Turning now to FIGS. 6 and 7, aspects of routines associated with resource information aggregation, publication, and/or matching are illustrated. For ease of understanding, the processes discussed in this disclosure are delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

With reference to FIG. 6, routine 600 begins at operation 602 where the cloud broker service 102 receives information from different cloud resource providers. The information can be included in a solicitation request and can include an amount of cloud resources that are available for consumption over a predefined period of time, a feature associated with the cloud resources that are available for consumption over the predefined period of time, and/or a cost associated with consuming a unit of the cloud resources that are available for consumption over the predefined period of time.

At operation 604, the cloud broker service 102 stores the information in a data structure which is configured to generate cloud resource offerings. Examples of the cloud resource offerings are described above with respect to FIG. 2.

At operation 606, the cloud broker service 102 can access the data structure to generate the cloud resource offerings for the predefined period of time. This access and generation can occur with respect to in a scheduled publication time.

At operation 608, the cloud broker service 102 publishes the cloud resource offerings for review by a plurality of cloud resource consumers.

At operation 610, the cloud broker service 102 receives, from a cloud resource consumer, a request to consume at least a portion of cloud resources from an identified cloud resource provider for execution of an application during the predefined period of time.

At operation 612, the cloud broker service 102 submits the request to the identified cloud resource provider thereby enabling the cloud resource provider to establish an agreement with the cloud resource consumer for allocation of the portion of the first cloud resources for execution of the application during the predefined period of time.

With reference to FIG. 7, routine 700 begins at operation 702 where the cloud broker service 102 receives information from different cloud resource providers. The information can be included in a solicitation request and can include an amount of cloud resources that are available for consumption over a predefined period of time, a feature associated with the cloud resources that are available for consumption over the predefined period of time, and/or a cost associated with consuming a unit of the cloud resources that are available for consumption over the predefined period of time.

At operation 704, the cloud broker service 102 stores the information in a data structure which is configured to generate cloud resource offerings. Examples of the cloud resource offerings are described above with respect to FIG. 2.

At operation 706, the cloud broker service 102 receives, from a cloud resource consumer, a request that specifies cloud resource consumption information associated with execution of an application during the predefined period of time. The cloud resource consumption information can include a requested amount of cloud resources and a requested feature associated with the cloud resources.

At operation 708, the cloud broker service 102 access the data structure to analyze the information received from each of the cloud resource providers.

At operation 710, the cloud broker service 102 identifies, based at least on the analysis of the information received from each of the cloud resource providers, at least one cloud resource provider that can satisfy the requested amount of cloud resources and the requested feature associated with the cloud resources.

At operation 712, the cloud broker service 102 provides, to the cloud resource consumer, at least one identification for the at least one cloud resource provider that can satisfy the requested amount of cloud resources and the requested feature associated with the cloud resources.

The various aspects of the disclosure are described herein with regard to certain examples and embodiments, which are intended to illustrate but not to limit the disclosure. It should be appreciated that the subject matter presented herein may be implemented as a computer process, a computer-controlled apparatus, a computing system, an article of manufacture, such as a computer-readable storage medium, or a component including hardware logic for implementing functions, such as a field-programmable gate array (FPGA) device, a massively parallel processor array (MPPA) device, a graphics processing unit (GPU), an application-specific integrated circuit (ASIC), a multiprocessor System-on-Chip (MPSoC), etc.

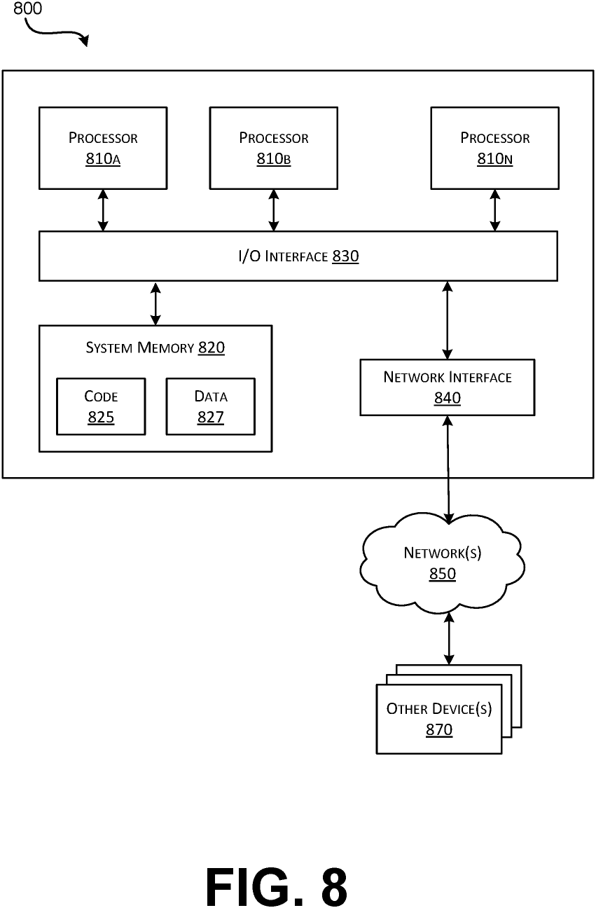

FIG. 8 illustrates a general-purpose computing device 800. In various examples, device 800 can be a server computer or any other sort of computing device that can serve as a physical host or other sort of computing device in the cloud platform. In the illustrated embodiment, computing device 800 includes one or more processors 810a, 810b, and/or 810n (which may be referred herein singularly as “a processor 810” or in the plural as “the processors 810”) coupled to a system memory 820 via an input/output (I/O) interface 830. Computing device 800 further includes a network interface 840 coupled to the I/O interface 830. In various embodiments, the processors 810 can be the processing cores described above.

In various embodiments, computing device 800 may be a multiprocessor system including several processors 810 (e.g., two, four, eight, or another suitable number). Processors 810 may be any suitable processors capable of executing instructions. For example, in various embodiments, processors 810 may be general-purpose or embedded processors implementing any of a variety of instruction set architectures (ISAs), such as the x77, PowerPC, SPARC, or MIPS ISAs, or any other suitable ISA. In multiprocessor systems, each of processors 810 may commonly, but not necessarily, implement the same ISA.

System memory 820 may be configured to store instructions and data accessible by processor(s) 810. In various embodiments, system memory 820 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those routines, techniques and data described above, are shown stored within system memory 820 as code 825 and data 827.

In one embodiment, the I/O interface 830 may be configured to coordinate I/O traffic between the processor 810, system memory 820, and any peripheral devices in the device, including network interface 840 or other peripheral interfaces. In some embodiments, the I/O interface 830 may perform any necessary protocol, timing, or other data transformations to convert data signals from one component (e.g., system memory 820) into a format suitable for use by another component (e.g., processor 810). In some embodiments, the I/O interface 830 may include support for devices attached through various types of peripheral buses, such as a variant of the Peripheral Component Interconnect (PCI) bus standard or the Universal Serial Bus (USB) standard, for example. In some embodiments, the function of I/O interface 830 may be split into two or more separate components. Also, in some embodiments some or all of the functionality of the I/O interface 830, such as an interface to system memory 820, may be incorporated directly into processor 810.

Network interface 840 may be configured to allow data to be exchanged between computing device 800 and other device or devices 870 attached to a network or network(s) 850, such as other computer systems or components illustrated in FIGS. 1 through 5, for example. In various embodiments, network interface 840 may support communication via any suitable wired or wireless general data networks. Additionally, network interface 840 may support communication via telecommunications/telephony networks such as analog voice networks or digital fiber communications networks, via storage area networks such as Fibre Channel SANs or via any other suitable type of network and/or protocol.

Network(s) 850 may include, for example, public networks such as the Internet, private networks such as an institutional and/or personal intranet, or some combination of private and public networks. Network(s) 850 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, 5G and so forth) or any combination thereof. Network(s) 850 may utilize communications protocols, including packet-based and/or datagram-based protocols such as Internet protocol (“IP”), transmission control protocol (“TCP”), user datagram protocol (“UDP”), or other types of protocols. Moreover, network(s) 850 may also include a number of devices that facilitate network communications and/or form a hardware basis for the networks, such as switches, routers, gateways, access points, firewalls, base stations, repeaters, backbone devices, and the like.

In some embodiments, system memory 820 may be one embodiment of a computer-accessible medium configured to store program instructions and data as described above for FIGS. 1-7. However, in other embodiments, program instructions and/or data may be received, sent or stored upon different types of computer-accessible media. A computer-accessible medium may include non-transitory storage media or memory media, such as magnetic or optical media, e.g., disk or DVD/CD coupled to computing device 800 via I/O interface 830. A non-transitory computer-accessible storage medium may also include any volatile or non-volatile media, such as RAM (e.g., SDRAM, DDR SDRAM, RDRAM, SRAM, etc.), ROM, etc., that may be included in some embodiments of computing device 800 as system memory 820 or another type of memory. Further, a computer-accessible medium may include transmission media or signals such as electrical, electromagnetic or digital signals, conveyed via a communication medium such as a network and/or a wireless link, such as may be implemented via network interface 840.

Portions or all of multiple computing devices, such as those illustrated in FIG. 8, may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “system” and/or “computing device,” as used herein, refers to at least all these types of devices and is not limited to these types of devices.

Various storage devices and their associated computer-readable media provide non-volatile storage for the computing devices described herein. Computer-readable media as discussed herein may refer to a mass storage device, such as a solid-state drive, a hard disk or CD-ROM drive. However, it should be appreciated by those skilled in the art that computer-readable media can be any available computer storage media that can be accessed by a computing device.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information, and which can be accessed by the computing devices discussed herein. For purposes of the claims, the phrase “computer storage medium,” “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the disclosed computing devices in order to store and execute the software components and/or functionality presented herein. It is also contemplated that the disclosed computing devices may not include all of the illustrated components shown in FIG. 8, may include other components that are not explicitly shown in FIG. 8, or may utilize an architecture completely different than that shown in FIG. 8.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The disclosure presented herein also encompasses the subject matter set forth in the following clauses.

Example A, a method comprising: receiving, at a cloud broker service and from each of a plurality of cloud resource providers, information that indicates: an amount of cloud resources that are available for consumption over a predefined period of time; and a feature associated with the cloud resources that are available for consumption over the predefined period of time; and storing, by the cloud broker service, the information received from each of the plurality of cloud resource providers in a data structure; receiving, at the cloud broker service and from a cloud resource consumer, a request that specifies cloud resource consumption information associated with execution of an application during the predefined period of time, wherein the cloud resource consumption information includes a requested amount of cloud resources and a requested feature associated with the cloud resources; accessing, by the cloud broker service, the data structure to analyze the information received from each of the plurality of cloud resource providers; identifying, by the cloud broker service and based at least on the analysis of the information received from each of the plurality of cloud resource providers, at least one cloud resource provider, amongst the plurality of cloud resource providers, that can satisfy the requested amount of cloud resources and the requested feature associated with the cloud resources; and providing, by the cloud broker service and to the cloud resource consumer, at least one identification for the at least one cloud resource provider that can satisfy the requested amount of cloud resources and the requested feature associated with the cloud resources.

Example B, the method of Example A, wherein the at least one cloud resource provider comprises multiple cloud resource providers and the information further indicates a cost associated with consuming a unit of the cloud resources that are available for consumption over the predefined period of time, the method further comprising: calculating, by the cloud broker service a total cost to the cloud resource consumer for each of the multiple cloud resource providers based on the requested amount of cloud resources and the requested feature associated with the cloud resources; ranking, by the cloud broker service, the multiple cloud resource providers based on the total costs calculated; providing, by the cloud broker service, the ranking of the multiple cloud resource providers to the cloud resource consumer; receiving, by the cloud broker service and from the cloud resource consumer, input that selects a cloud resource provider from the ranking of the multiple cloud resource providers; and submitting, by the cloud broker service and based on the input, the request to the selected cloud resource provider thereby enabling the selected cloud resource provider to establish an agreement with the cloud resource consumer for the execution of the application during the predefined period of time.

Example C, the method of Example A or Example B, further comprising: publishing, by the cloud broker service at a first scheduled time, the information for review by a plurality of cloud resource consumers; and imposing a deadline for each of the plurality of cloud resource providers to submit the information, wherein the deadline is at a second scheduled time that is a predetermined amount of time before the first scheduled time.

Example D, the method of any one of Examples A through C, wherein the feature designates a geographic region in which the cloud resources are located.

Example E, the method of any one of Examples A through D, wherein the cloud resources comprise at least one of processing resources, storage resources, or networking resources.

Example F, the method of any one of Examples A through E, wherein the predefined period of time comprises twelve hours, one day, two days, three days, four days, five days, six days, seven days, or one month.

Example G, a method implemented by a service configured to connect cloud resource consumers with a plurality of cloud resource providers, the method comprising: receiving, from a first cloud resource provider, first information that indicates: an amount of first cloud resources that are available for consumption over a predefined period of time; a feature associated with the first cloud resources that are available for consumption over the predefined period of time; and a cost associated with consuming a unit of the first cloud resources that are available for consumption over the predefined period of time; receiving, from a second cloud resource provider, second information that indicates: an amount of second cloud resources that are available for consumption over the predefined period of time; a feature associated with the second cloud resources that are available for consumption over the predefined period of time; and a cost associated with consuming a unit of the second cloud resources that are available for consumption over the predefined period of time; storing, by one or more processing units, the first information and the second information in a data structure which is configured to generate cloud resource offerings, wherein: a first cloud resource offering includes the first information; and a second cloud resource offering includes the second information; in association with a scheduled publication time, accessing the data structure to generate the cloud resource offerings for the predefined period of time; publishing the cloud resource offerings for review by the plurality of cloud resource consumers; receiving, from a cloud resource consumer of the plurality of cloud resource consumers, a request to consume at least a portion of the first cloud resources for execution of an application during the predefined period of time; and submitting the request to the first cloud resource provider thereby enabling the first cloud resource provider to establish an agreement with the cloud resource consumer for allocation of the portion of the first cloud resources for execution of the application during the predefined period of time.

Example H, the method of Example G, further comprising imposing a deadline for each of the first cloud resource provider and the second cloud resource provider to respectively submit the first information and the second information, wherein the deadline is at a scheduled submission time that is a predetermined amount of time before the scheduled publication time.

Example I, the method of Example G or Example H, wherein the feature designates a geographic region in which the first cloud resources or the second cloud resources are located.

Example J, the method of any one of Examples G through I, wherein each of the first cloud resources and the second cloud resources comprises at least one of processing resources, storage resources, or networking resources.

Example K, the method of any one of Examples G through J, wherein the predefined period of time comprises twelve hours, one day, two days, three days, four days, five days, six days, seven days, or one month.

Example L, the method of any one of Examples G through K, further comprising refraining from further publishing the cloud resource offerings for review by the plurality of cloud resource consumers upon expiration of the predefined period of time.

Example M, the method of any one of Examples G through L, wherein the first information is prevented from being disclosed to the second cloud resource provider, and the second information is prevented from being disclosed to the first cloud resource provider, prior to the scheduled publication time.

Example N, a system that implements a service configured to connect cloud resource consumers with a plurality of cloud resource providers, comprising: one or more processors; and computer storage media storing instructions that, when executed by the one or more processors, cause the system to perform operations comprising: receiving, from a first cloud resource provider, first information that indicates: an amount of first cloud resources that are available for consumption over a predefined period of time; a feature associated with the first cloud resources that are available for consumption over the predefined period of time; and a cost associated with consuming a unit of the first cloud resources that are available for consumption over the predefined period of time; receiving, from a second cloud resource provider, second information that indicates: an amount of second cloud resources that are available for consumption over the predefined period of time; a feature associated with the second cloud resources that are available for consumption over the predefined period of time; and a cost associated with consuming a unit of the second cloud resources that are available for consumption over the predefined period of time; storing the first information and the second information in a data structure which is configured to generate cloud resource offerings, wherein: a first cloud resource offering includes the first information; and a second cloud resource offering includes the second information; in association with a scheduled publication time, accessing the data structure to generate the cloud resource offerings for the predefined period of time; publishing the cloud resource offerings for review by the plurality of cloud resource consumers; receiving, from a cloud resource consumer of the plurality of cloud resource consumers, a request to consume at least a portion of the first cloud resources for execution of an application during the predefined period of time; and submitting the request to the first cloud resource provider thereby enabling the first cloud resource provider to establish an agreement with the cloud resource consumer for allocation of the portion of the first cloud resources for execution of the application during the predefined period of time.

Example O, the system of Example N, wherein the operations further comprise imposing a deadline for each of the first cloud resource provider and the second cloud resource provider to respectively submit the first information and the second information, wherein the deadline is at a scheduled submission time that is a predetermined amount of time before the scheduled publication time.

Example P, the system of Example N or Example O, wherein the feature designates a geographic region in which the first cloud resources or the second cloud resources are located.

Example Q, the system of any one of Examples N through P, wherein each of the first cloud resources and the second cloud resources comprises at least one of processing resources, storage resources, or networking resources.

Example R, the system of any one of Examples N through Q, wherein the predefined period of time comprises twelve hours, one day, two days, three days, four days, five days, six days, seven days, or one month.

Example S, the system of any one of Examples N through R, wherein the operations further comprise refraining from further publishing the cloud resource offerings for review by the plurality of cloud resource consumers upon expiration of the predefined period of time.

Example T, the system of any one of Examples N through S, wherein the first information is prevented from being disclosed to the second cloud resource provider, and the second information is prevented from being disclosed to the first cloud resource provider, prior to the scheduled publication time.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different cloud resource providers, two different cloud resource consumers, etc.).

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method implemented by a cloud broker service configured between a plurality of cloud resource providers and a cloud resource consumption device, comprising:
receiving, from each of the plurality of cloud resource providers, information that indicates:
an amount of cloud resources that are available for consumption over a predefined period of time; and
a feature associated with the cloud resources that are available for consumption over the predefined period of time; and
storing the information received from each of the plurality of cloud resource providers in a data structure;
receiving, from the cloud resource consumption device, a request that specifies cloud resource consumption information associated with execution of an application during the predefined period of time, wherein the cloud resource consumption information includes a requested amount of cloud resources and a requested feature associated with the cloud resources;
accessing the data structure to analyze the information received from each of the plurality of cloud resource providers;
identifying, based at least on the analysis of the information received from each of the plurality of cloud resource providers, at least one cloud resource provider, amongst the plurality of cloud resource providers, that can satisfy the requested amount of cloud resources and the requested feature associated with the cloud resources; and
providing, to the cloud resource consumption device, at least one identification for the at least one cloud resource provider that can satisfy the requested amount of cloud resources and the requested feature associated with the cloud resources.

2. The method of claim 1, wherein the at least one cloud resource provider comprises multiple cloud resource providers and the information further indicates a cost associated with consuming a unit of the cloud resources that are available for consumption over the predefined period of time, the method further comprising:
calculating a total cost to the cloud resource consumer for each of the multiple cloud resource providers based on the requested amount of cloud resources and the requested feature associated with the cloud resources;
ranking the multiple cloud resource providers based on the total costs calculated;
providing the ranking of the multiple cloud resource providers to the cloud resource consumption device;
receiving, from the cloud resource consumption device, input that selects a cloud resource provider from the ranking of the multiple cloud resource providers; and
submitting, based on the input, the request to the selected cloud resource provider thereby enabling the selected cloud resource provider to establish an agreement with the cloud resource consumption device for the execution of the application during the predefined period of time.

3. The method of claim 1, further comprising:
publishing at a first scheduled time, the information for review by a plurality of cloud resource consumers; and
imposing a deadline for each of the plurality of cloud resource providers to submit the information, wherein the deadline is at a second scheduled time that is a predetermined amount of time before the first scheduled time.

4. The method of claim 1, wherein the feature designates a geographic region in which the cloud resources are located.

5. The method of claim 1, wherein the cloud resources comprise at least one of processing resources, storage resources, or networking resources.

6. The method of claim 1, wherein the predefined period of time comprises twelve hours, one day, two days, three days, four days, five days, six days, seven days, or one month.

7. A method implemented by a service configured to connect cloud resource consumers with a plurality of cloud resource providers, the method comprising:
receiving, from a first cloud resource provider, first information that indicates:
an amount of first cloud resources that are available for consumption over a predefined period of time;
a feature associated with the first cloud resources that are available for consumption over the predefined period of time; and
a cost associated with consuming a unit of the first cloud resources that are available for consumption over the predefined period of time;
receiving, from a second cloud resource provider, second information that indicates:
an amount of second cloud resources that are available for consumption over the predefined period of time;
a feature associated with the second cloud resources that are available for consumption over the predefined period of time; and
a cost associated with consuming a unit of the second cloud resources that are available for consumption over the predefined period of time;
storing, by one or more processing units, the first information and the second information in a data structure which is configured to generate cloud resource offerings, wherein:
a first cloud resource offering includes the first information; and
a second cloud resource offering includes the second information;
in association with a scheduled publication time, accessing the data structure to generate the cloud resource offerings for the predefined period of time;
publishing the cloud resource offerings for review by the plurality of cloud resource consumers;
receiving, from a cloud resource consumer of the plurality of cloud resource consumers, a request to consume at least a portion of the first cloud resources for execution of an application during the predefined period of time; and
submitting the request to the first cloud resource provider thereby enabling the first cloud resource provider to establish an agreement with the cloud resource consumer for allocation of the portion of the first cloud resources for execution of the application during the predefined period of time.

8. The method of claim 7, further comprising imposing a deadline for each of the first cloud resource provider and the second cloud resource provider to respectively submit the first information and the second information, wherein the deadline is at a scheduled submission time that is a predetermined amount of time before the scheduled publication time.

9. The method of claim 7, wherein the feature designates a geographic region in which the first cloud resources or the second cloud resources are located.

10. The method of claim 7, wherein each of the first cloud resources and the second cloud resources comprises at least one of processing resources, storage resources, or networking resources.

11. The method of claim 7, wherein the predefined period of time comprises twelve hours, one day, two days, three days, four days, five days, six days, seven days, or one month.

12. The method of claim 7, further comprising refraining from further publishing the cloud resource offerings for review by the plurality of cloud resource consumers upon expiration of the predefined period of time.

13. The method of claim 7, wherein the first information is prevented from being disclosed to the second cloud resource provider, and the second information is prevented from being disclosed to the first cloud resource provider, prior to the scheduled publication time.

14. A system that implements a service configured to connect cloud resource consumers with a plurality of cloud resource providers, comprising:
one or more processors; and
computer storage media storing instructions that, when executed by the one or more processors, cause the system to perform operations comprising:
receiving, from a first cloud resource provider, first information that indicates:
an amount of first cloud resources that are available for consumption over a predefined period of time;
a feature associated with the first cloud resources that are available for consumption over the predefined period of time; and
a cost associated with consuming a unit of the first cloud resources that are available for consumption over the predefined period of time;
receiving, from a second cloud resource provider, second information that indicates:
an amount of second cloud resources that are available for consumption over the predefined period of time;
a feature associated with the second cloud resources that are available for consumption over the predefined period of time; and
a cost associated with consuming a unit of the second cloud resources that are available for consumption over the predefined period of time;
storing the first information and the second information in a data structure which is configured to generate cloud resource offerings, wherein:
a first cloud resource offering includes the first information; and
a second cloud resource offering includes the second information;
in association with a scheduled publication time, accessing the data structure to generate the cloud resource offerings for the predefined period of time;
publishing the cloud resource offerings for review by the plurality of cloud resource consumers;
receiving, from a cloud resource consumer of the plurality of cloud resource consumers, a request to consume at least a portion of the first cloud resources for execution of an application during the predefined period of time; and
submitting the request to the first cloud resource provider thereby enabling the first cloud resource provider to establish an agreement with the cloud resource consumer for allocation of the portion of the first cloud resources for execution of the application during the predefined period of time.

15. The system of claim 14, wherein the operations further comprise imposing a deadline for each of the first cloud resource provider and the second cloud resource provider to respectively submit the first information and the second information, wherein the deadline is at a scheduled submission time that is a predetermined amount of time before the scheduled publication time.

16. The system of claim 14, wherein the feature designates a geographic region in which the first cloud resources or the second cloud resources are located.

17. The system of claim 14, wherein each of the first cloud resources and the second cloud resources comprises at least one of processing resources, storage resources, or networking resources.

18. The system of claim 14, wherein the predefined period of time comprises twelve hours, one day, two days, three days, four days, five days, six days, seven days, or one month.

19. The system of claim 14, wherein the operations further comprise refraining from further publishing the cloud resource offerings for review by the plurality of cloud resource consumers upon expiration of the predefined period of time.

20. The system of claim 14, wherein the first information is prevented from being disclosed to the second cloud resource provider, and the second information is prevented from being disclosed to the first cloud resource provider, prior to the scheduled publication time.
